(19) United States
(12) Patent Application Publication
(10) Pub. No.: US 2026/0299818 A1
(43) Pub. Date: Oct. 1, 2026

(54) ERASURE CODING PROTECTION FOR OBJECT STORE METADATA

(71) Applicant: Rakuten Mobile, Inc., Tokyo (JP)

(72) Inventors: Sree Nandan Atur, San Mateo, CA (US); Nilesh Sitaram Somani, San Mateo, CA (US); Kallur Vasudeva Rao Narasimha Subban, San Mateo, CA (US)

(21) Appl. No.: 19/092,256

(22) Filed: Mar. 27, 2025

(51) Int. Cl. G06F 3/06

(52) U.S. Cl. CPC G06F 3/0655; G06F 3/0604; G06F 3/0679

(57) ABSTRACT

A system includes an object store that receives a data object including data and metadata and stores the data in one or more first storage devices. The object store writes the metadata to a redundant database. The redundant database writes a leader copy of the metadata to an ephemeral storage volume implemented by one or more second storage devices and invokes writing of an erasure coded backup copy of the metadata to a plurality of third storage devices.

### FIELD

The present disclosure relates to providing erasure coding protection for object store metadata.

### BACKGROUND

The information disclosed in this background section is only for enhancement of understanding of the general background of the disclosure and should not be taken as an acknowledgement or any form of suggestion that this information forms the prior art already known to a person skilled in the art.

In an object store, data and metadata serve distinct purposes. Data represents the actual content stored, such as files, images, videos, audio files, and documents, typically in binary format. Metadata, on the other hand, provides descriptive information about the data, offering context, attributes, and properties which facilitate easier management, search, and retrieval.

### SUMMARY

In one aspect, a system includes an object store. The object store receives a data object including data and metadata and stores the data in one or more first storage devices. The object store writes the metadata to a redundant database. The redundant database writes a leader copy of the metadata to an ephemeral storage volume implemented by one or more second storage devices and invokes writing of an erasure coded backup copy of the metadata to a plurality of third storage devices.

In another aspect, a method includes receiving, by an object store executing in a computer system, a data object including data and metadata. The method includes storing, by the object store, the data in one or more first storage devices. The method includes writing, by the object store, the metadata to a redundant database executing in the computer system. The method further includes performing, by the redundant database: writing a leader copy of the metadata to an ephemeral storage volume implemented by one or more second storage devices and invoking writing of an erasure coded backup copy of the metadata to a plurality of third storage devices.

In another aspect, a non-transitory computer-readable medium stores executable code configured to cause a computer system to receive, by an object store, a data object including data and metadata and store, by the object store, the data in one or more first storage devices. The object store writes the metadata to a redundant database. The redundant database writes a leader copy of the metadata to an ephemeral storage volume implemented by one or more second storage devices and invokes writing of an erasure coded backup copy of the metadata to a plurality of third storage devices.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a system for writing data objects using erasure coding of metadata in accordance with an embodiment;

FIG. 2 is a process flow diagram of a method for writing data objects using erasure coding of metadata in accordance with an embodiment;

FIG. 3 is a process flow diagram of a method for restoring metadata in accordance with an embodiment; and

FIG. 5 is a schematic block diagram of an example computing device suitable for implementing methods in accordance with embodiments of the disclosure

### DETAILED DESCRIPTION

The following detailed description of example embodiments refers to the accompanying drawings. The present disclosure provides illustrations and descriptions but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

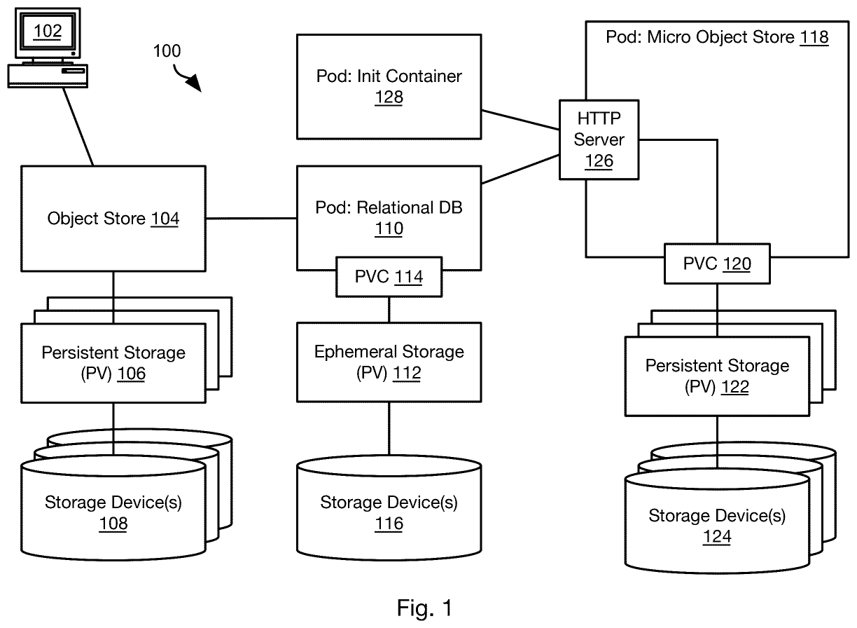

FIG. 1 illustrates a system 100 for storing data objects. An object store may include data and metadata, which are two distinct types of information stored in the system. Data refers to the actual content or payload stored in the object store. This can include files, images, videos, audio files, documents, and other types of digital content. Data is the primary purpose of an object store, and it is typically stored in a binary format. Metadata refers to additional information that describes the data stored in the object store. Metadata is used to provide context, attributes, and properties about the data, making the data easier to manage, search, and retrieve.

While data is stored on disks using erasure coding, metadata could be stored separately in a central database or along with data. Some tools, such as MINIO, do not use a separate database for metadata due to scale and fault tolerance. In such tools, metadata is instead stored along with data on the same storage device. In MESSAGEPACK, metadata is stored in a binary format with serialization formatting, which provides JAVASCRIPT object notation (JSON) functionality for key add and remove. MESSSAGEPACK therefore provides a fast and small solution.

Different operations on an object store require reads and writes on data and metadata. There are implications to storing data and metadata on the same storage device. Input/output (I/O) is a zero-sum game. Optimizing performance for metadata has effects on data and vice-versa as all I/O operations compete for shared resources, such as CPU cycles, memory bandwidth, and storage capacity. I/O is also limited by the storage device's cache size and interface. From the performance perspective, every I/O count, i.e., more metadata IO means less data IO and more data IO means less metadata IO.

Operations that involve large amounts of metadata, such as listing of metadata at scale, can result in an explosion of random I/O to disks, which significantly impacts the processing of queued data I/O. As the metadata file is stored on disk, processing queries involves reading metadata into memory, deserializing it and then applying the query, which is slow and memory intensive.

In addition, object storage is typically used for workloads like analytics, datasets, logs and backups. Relational ACID (atomicity, consistency, isolation, durability) compliant POSTGRESQL databases do not provide erasure coding, they follow replicated pattern of storing data in Leader/Sync Replica/Async Replica. This means for erasure coding of “k+m” where k=num data disks and m=num parity disks, for redundancy and high availability with POSTGRESQL, one would have to store full copies of metadata “m+1” times which is very slow and becomes expensive at higher k+m values.

The deficiencies of prior approaches may be ameliorated using the approach described herein with respect to FIGS. 1 through 3. In the approach described herein, the data and metadata are stored in separate disks, enabling the optimization of performance of I/O reads and writes with respect to different storage devices. Metadata may be stored in an ACID compliant relational database like POSTGRES for reads/writes and superior query performance. With this isolation, improved performance and query capabilities may be achieved. Fault tolerance may be addressed separately from the ACID compliant relational database. Specifically, erasure coding of metadata separately from the ACID compliant relational database may also be performed.

Referring specifically to FIG. 1, a system 100 for storing objects may have some or all of the illustrated components. The illustrated components may reside on a common node or separate computing nodes such that the communication among components is performed over a network. System 100 may receive objects to store and requests to retrieve stored objects from a computing device 102. The computing device 102 may be a server system, user computing device, or other type of computing device.

The system 100 may include an object store 104 that receives objects for storage and requests to retrieve stored objects. The object store 104 may store data for each object using a persistent storage system 106, e.g., persistent volume (PV) managing the storing of data in one or more storage devices 108. The persistent storage system 106 and one or more storage devices 108 may store the data in any way known in the art, including any approach known in the art for providing redundancy and data recovery.

Metadata for objects may be stored using the remaining components of the system 100. In particular, the data and metadata may be stored in different storage devices and the metadata may be stored using the approach described herein to provide high availability and redundancy without interfering with access to the data.

Metadata may be stored to a relational database module 110. The relational database module 110 may implement an ACID compliant relational database, such as POSTGRES. The relational database module 110 may be implemented using a pod, such as a KUBERNETES pod. The relational database module 110 may interface with an ephemeral storage system 112, which may be implemented as a persistent volume (PV). The ephemeral storage system 112 may be so designated because it lacks redundancy, erasure coding, or other data structures to guarantee data availability. For example, an ephemeral storage system 112 according to KUBERNETES does not provide for persistent storage of data across restarts of the ephemeral storage system 112. The relational database module 110 may implement a persistent volume claim 114 interfacing with the ephemeral storage system 112. The ephemeral storage system 112 may manage storage of data in the one or more storage devices 116.

The relational database module 110 may further interface with a micro object store 118, that may likewise execute within a pod that is the same pod or a different pod than the relational database module 110. The micro object store 118 may include a PVC 120 interfacing with a plurality of persistent storage modules 122, each of which may be a PV. Each persistent storage module 122 may manage the storage and access of data relative to one or more storage devices 124. In order to provide redundancy, each persistent storage module 122 may interface with different one or more storage devices 124 than every other persistent storage module 122. The micro object store 118 may further implement an HTTP server 126 for receiving data stored and accessed using the micro object store 118. The micro object store 118 may register the HTTP server 126 and a corresponding port with the relational database module 110 to receive write access log (WAL) updates from the relational database module 110, e.g., the output of the pg_receivewal function (synchronous or asynchronous). The HTTP server 126 may interact with the PVC 120 to write to the persistent storage module 122, such as in the form of PUT commands. Likewise, the HTTP server 126 may read data from the persistent storage module 122 by submitting GET commands to the PVC 120.

The system may include an init container 128. The init container 128 may execute in a pod that is the same pod or a different pod than those executing the relational database module 110 and micro object store 118. The init containers 128 may manage bringing up the relational database module 110 and possibly the micro object store 118. In particular, as discussed below, the init container 128 may manage the restoration of metadata to the ephemeral storage system 112 when the ephemeral storage system 112 is started, such as after a failure.

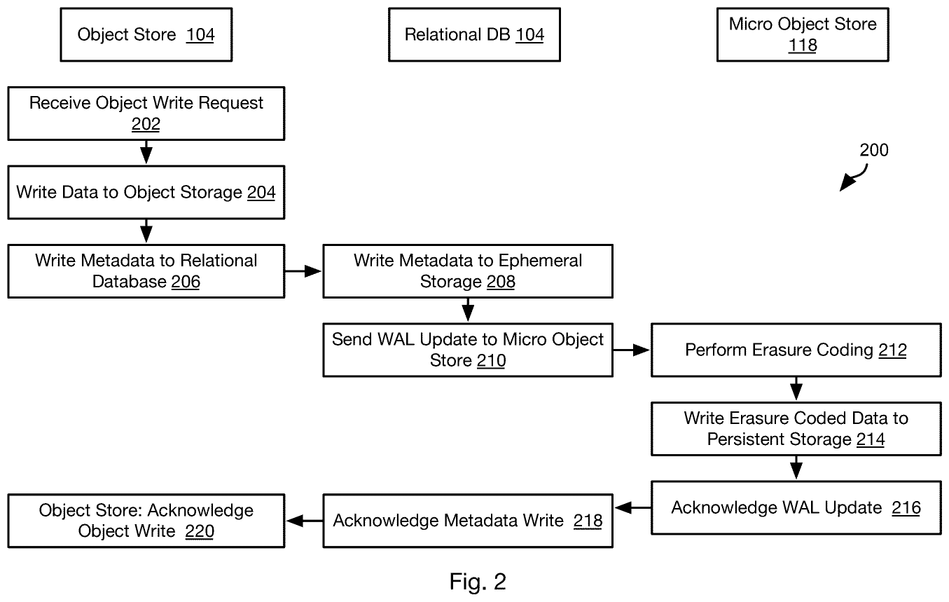

FIG. 2 illustrates a method 200 explaining operation of the system 100. The method 200 may include the object store 104 receiving an object write request at step 202, the object write request including data and corresponding metadata. The object store 104 writes the data to object storage at step 204, e.g., to persistent storage system 106 and ultimately to the one or more storage devices 108. The object store 104 may write the metadata to the relational database module 110 at step 206. Step 206 may include sending a write request with the metadata to a relational database implemented by the relational database module 110.

The relational database module 110 receives the write request and writes the metadata to ephemeral storage system 112 at step 208 such that the data is ultimately written to the one or more storage devices 116. The copy of the metadata and all other metadata written to the one or more storage devices 116 may be available through the relational database module 110 to respond to queries for specific metadata or more advanced queries according to any database language known in the art such as structured query language (SQL) statements, such as POSTGRESSQL statements. The POSTGRES module 110 may store the metadata within the one or more storage devices as a database, such as a relational database. The relational database module 110 may store the metadata as a leader copy of a database according to the POSTGRES standard.

The relational database module 110 may send a write access log (WAL) update to the micro object store 118 at step 210 in response to the receiving the metadata at step 206. The WAL update may include the metadata and be generated according to the POSTGRES standard to facilitate creating one or more redundant copies of the metadata. In some embodiments, the WAL update is a 16 megabyte file by default. Each change written to the file may be indicated by a logical sequence number (LSN). Generation of the WAL update may be performed according to various functions of the POSTGRESQL, such as using pg_basebackup for full backup of a data directory and using wal-g/wal-e nd for continuous WAL archiving, which provides point in time recovery (PITR).

The micro object store 118 may perform various actions with respect to the WAL update in order to implement a replica of the metadata. In particular, the micro object store may perform erasure coding of the WAL update (e.g., the metadata) at step 212. Erasure coding may include generating multiple encoded blocks encoding the WAL update such that a subset of the data blocks is sufficient to recover the WAL update. In particular, erasure coding may include breaking up the WAL update into pieces and padding the pieces with codes that encode data in the remaining pieces, each piece and the corresponding codes may form an encoded block. For example, step 212 may include performing “k+m” erasure coding in which k blocks are created that can tolerate at least m failures, where k and m are integers and k is greater than m.

The micro object store 118 may write the encoded blocks to a plurality of persistent storage modules 122 at step 214, e.g., one encoded block per persistent storage module 122, and ultimately to the one or more storage devices 124, such that each encoded block is stored on a separate storage device 124 from the remaining encoded blocks. Persistent volumes managed by the persistent storage modules 122 may be pre-created prior to receiving the WAL updates to speed up creation of erasure encoded replicas.

Once the writes of step 214 are acknowledged as being complete by the persistent storage modules 122, the micro object store 118 may acknowledge writing of the WAL update to the relational database module 110 at step 216. In response to receiving acknowledgment from the micro object store 118 and in response to completion of the write to the ephemeral storage system 112 from step 208, the relational database module 110 may acknowledge completion of writing of the metadata at step 218, such as by transmitting an acknowledgment of writing of the metadata to the object store 104. Upon receiving the acknowledgment from the relational database module 110, the object store 104 may acknowledge completion of writing of the object at step 220, such as by transmitting acknowledgment to a source of the write request from step 202, e.g., the computing device 102.

Various modifications of the method 200 may be implemented. For example, the method 200 is a synchronous method in which writing of an object is not acknowledged until storage of erasure coded copies of the metadata is complete. In other embodiments, acknowledgment of writing of the WAL updates (steps 216, 218) is omitted and the relational database module 110 may acknowledge writing of metadata once successfully written to the ephemeral storage system 112. For example, WAL updates may be transmitted by the relational database module 110 in the asynchronous mode provided for in the POSTGRES standard.

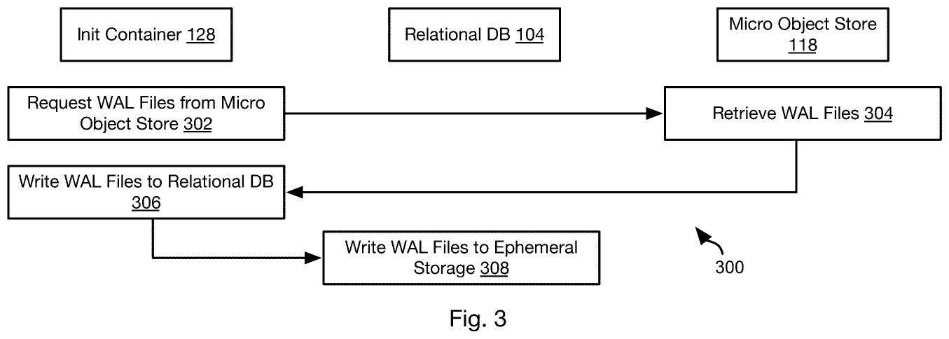

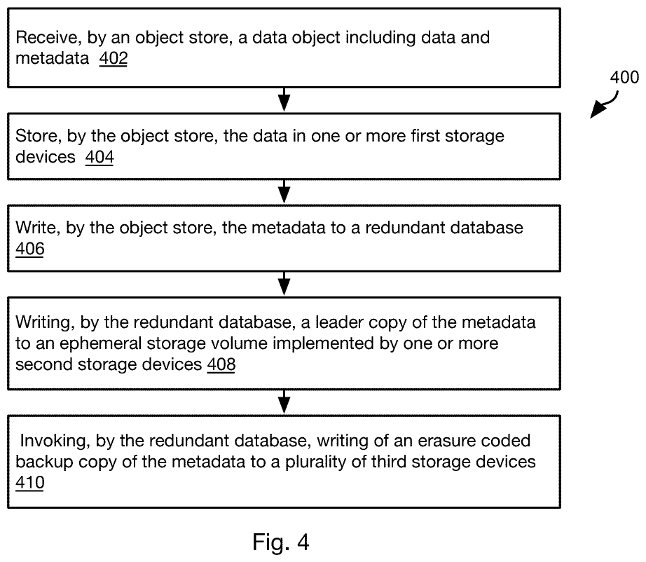

FIG. 3 illustrates a method 300 that may be performed using the system 100 to recover metadata in the event that the copy managed by the ephemeral storage system 112 is lost, e.g., due to failure, corruption, or other fault of the one or more storage devices 116. The method 300 may be invoked by the init container 128 in response to a triggering event, such as detecting that a component has just come back online, such as the relational database module 110, PVC 114, ephemeral storage system 112, the init container 128 itself, and/or the one or more storage devices 116.

The init container 128 may request WAL files from the micro object store 118 at step 302. For example, the init container 128 may request all WAL files transmitted from the relational database module 110 or having some other label. The micro object store 118 may then retrieve the requested WAL files at step 304 and write the WAL files to the relational database module 110 at step 306. The relational database module 110 may then write the metadata from the WAL files to the ephemeral storage system 112 at step 308.

The approach described herein above provides improved performance by storing metadata separate from data in an object store. In addition, advanced query capabilities with respect to metadata are achieved by using a relational database and an ephemeral storage volume. Redundant storage is achieved using separate erasure coding of backup copies of the relational database.

FIG. 4 illustrates a method 400 that may be performed using a system, such as the system 100. The method 400 may include receive, at step 402, by an object store, a data object including data and metadata; storing, at step 404, by the object store, the data in one or more first storage devices; writing, at step 406, by the object store, the metadata to a redundant database; and perform, by the redundant database: writing, at step 408, a leader copy of the metadata to an ephemeral storage volume implemented by one or more second storage devices; and invoking, at step 410, writing of an erasure coded backup copy of the metadata to a plurality of third storage devices.

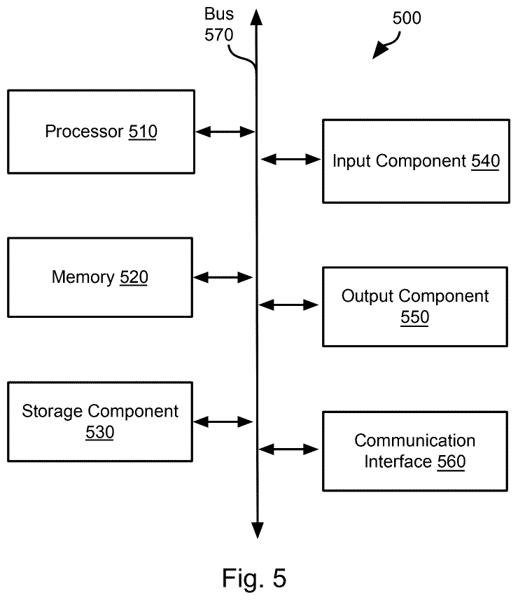

FIG. 5 illustrates an embodiment of a computing device 500 that may be used to implement some or all of the components of the system 100. As shown in FIG. 5, the computing device 500 includes a processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, instructions to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

In a first example embodiments, a system is configured to: receive, by an object store, a data object including data and metadata; store, by the object store, the data in one or more first storage devices; write, by the object store, the metadata to a redundant database; and perform, by the redundant database: writing a leader copy of the metadata to an ephemeral storage volume implemented by one or more second storage devices; and invoking writing of an erasure coded backup copy of the metadata to a plurality of third storage devices.

In a second example embodiment of the first example embodiment, the redundant database is an atomicity, consistency, isolation, durability (ACID) compliant relational database.

In a third example embodiment of the second example embodiment, the redundant database is a POSTGRES database.

In a fourth example embodiment of the third example embodiment, invoking writing of the erasure coded backup copy of the metadata to the plurality of third storage devices comprises writing write access log (WAL) updates for the POSTGRES database to a micro object store, the micro object store configured to write the WAL updates to the plurality of third storage devices using erasure coding.

In a fifth example embodiment of the fourth example embodiment, writing the WAL updates for the POSTGRES database to the micro object store comprises interfacing with a hypertext transfer protocol (HTTP) server on the micro object store.

In a sixth example embodiment of the fourth example embodiment, the micro object store includes persistent volume claims (PVC) to a plurality of persistent volumes (PV) managing access to the plurality of third storage devices.

In a seventh example embodiment of the first example embodiment, the system is further configured to restore the metadata to the ephemeral storage volume from the erasure coded backup copy upon restart of the redundant database.

In an eighth example embodiment of the first example embodiment, the system comprises an init container configured to restore the metadata to the ephemeral storage volume from the erasure coded backup copy upon restart of the redundant database.

In a ninth example embodiment of the first example embodiment, the redundant database includes a persistent volume claim (PVC) configured to interface with the ephemeral storage volume.

In a tenth example embodiment of the first example embodiment, the redundant database is configured to process queries with respect to the metadata.

In an eleventh example embodiment, a method includes: receiving, by an object store executing in a computer system, a data object including data and metadata; storing, by the object store, the data in one or more first storage devices; writing, by the object store, the metadata to a redundant database executing in the computer system; and performing, by the redundant database: writing a leader copy of the metadata to an ephemeral storage volume implemented by one or more second storage devices; and invoking writing of an erasure coded backup copy of the metadata to a plurality of third storage devices.

In a twelfth example embodiment of the eleventh example embodiment, the redundant database is an atomicity, consistency, isolation, durability (ACID) compliant relational database.

In a thirteenth example embodiment of the twelfth example embodiment, the redundant database is a POSTGRES database.

In a fourteenth example embodiment of the thirteenth example embodiment, invoking writing of the erasure coded backup copy of the metadata to the plurality of third storage devices comprises writing write access log (WAL) updates for the POSTGRES database to a micro object store, the micro object store configured to write the WAL updates to the plurality of third storage devices using erasure coding.

In a fifteenth example embodiment of the fourteenth example embodiment, writing the WAL updates for the POSTGRES database to the micro object store comprises interfacing with a hypertext transfer protocol (HTTP) server on the micro object store.

In a sixteenth example embodiment of the fourteenth example embodiment, the micro object store includes persistent volume claims (PVC) to a plurality of persistent volumes (PV) managing access to the plurality of third storage devices.

In a seventeenth example embodiment of the eleventh example embodiment, the method further includes restoring the metadata to the ephemeral storage volume from the erasure coded backup copy upon restart of the redundant database.

In an eighteenth example embodiment of the eleventh example embodiment, the method includes restoring the metadata to the ephemeral storage volume from the erasure coded backup copy upon restart of the redundant database using an init container.

In a nineteenth example embodiment of the eleventh example embodiment, the redundant database includes a persistent volume claim (PVC) configured to interface with the ephemeral storage volume.

In a twentieth example embodiment a non-transitory computer-readable medium storing executable code configured to cause a computer system to: receive, by an object store, a data object including data and metadata; store, by the object store, the data in one or more first storage devices; write, by the object store, the metadata to a redundant database; and perform, by the redundant database: writing a leader copy of the metadata to an ephemeral storage volume implemented by one or more second storage devices; and invoking writing of an erasure coded backup copy of the metadata to a plurality of third storage devices.

1. A system configured to:
receive, by an object store, a data object including data and metadata;
store, by the object store, the data in one or more first storage devices;
write, by the object store, the metadata to a redundant database; and
perform, by the redundant database:
writing a leader copy of the metadata to an ephemeral storage volume implemented by one or more second storage devices; and
invoking writing of an erasure coded backup copy of the metadata to a plurality of third storage devices.

2. The system of claim 1, wherein the redundant database is an atomicity, consistency, isolation, durability (ACID) compliant relational database.

3. The system of claim 2, wherein the redundant database is a POSTGRES database.

4. The system of claim 3, wherein invoking writing of the erasure coded backup copy of the metadata to the plurality of third storage devices comprises writing write access log (WAL) updates for the POSTGRES database to a micro object store, the micro object store configured to write the WAL updates to the plurality of third storage devices using erasure coding.

5. The system of claim 4, wherein writing the WAL updates for the POSTGRES database to the micro object store comprises interfacing with a hypertext transfer protocol (HTTP) server on the micro object store.

6. The system of claim 4, wherein the micro object store includes persistent volume claims (PVC) to a plurality of persistent volumes (PV) managing access to the plurality of third storage devices.

7. The system of claim 1, wherein the system is further configured to restore the metadata to the ephemeral storage volume from the erasure coded backup copy upon restart of the redundant database.

8. The system of claim 1, wherein the system comprises an init container configured to restore the metadata to the ephemeral storage volume from the erasure coded backup copy upon restart of the redundant database.

9. The system of claim 1, wherein the redundant database includes a persistent volume claim (PVC) configured to interface with the ephemeral storage volume.

10. The system of claim 1, wherein the redundant database is configured to process queries with respect to the metadata.

11. A method comprising:
receiving, by an object store executing in a computer system, a data object including data and metadata;
storing, by the object store, the data in one or more first storage devices;
writing, by the object store, the metadata to a redundant database executing in the computer system; and
performing, by the redundant database:
writing a leader copy of the metadata to an ephemeral storage volume implemented by one or more second storage devices; and
invoking writing of an erasure coded backup copy of the metadata to a plurality of third storage devices.

12. The method of claim 11, wherein the redundant database is an atomicity, consistency, isolation, durability (ACID) compliant relational database.

13. The method of claim 12, wherein the redundant database is a POSTGRES database.

14. The method of claim 13, wherein invoking writing of the erasure coded backup copy of the metadata to the plurality of third storage devices comprises writing write access log (WAL) updates for the POSTGRES database to a micro object store, the micro object store configured to write the WAL updates to the plurality of third storage devices using erasure coding.

15. The method of claim 14, wherein writing the WAL updates for the POSTGRES database to the micro object store comprises interfacing with a hypertext transfer protocol (HTTP) server on the micro object store.

16. The method of claim 14, wherein the micro object store includes persistent volume claims (PVC) to a plurality of persistent volumes (PV) managing access to the plurality of third storage devices.

17. The method of claim 11, further comprising restoring the metadata to the ephemeral storage volume from the erasure coded backup copy upon restart of the redundant database.

18. The method of claim 11, further comprising restoring the metadata to the ephemeral storage volume from the erasure coded backup copy upon restart of the redundant database using an init container.

19. The method of claim 11, wherein the redundant database includes a persistent volume claim (PVC) configured to interface with the ephemeral storage volume.

20. A non-transitory computer-readable medium storing executable code configured to cause a computer system to:
receive, by an object store, a data object including data and metadata;
store, by the object store, the data in one or more first storage devices;
write, by the object store, the metadata to a redundant database; and
perform, by the redundant database:
writing a leader copy of the metadata to an ephemeral storage volume implemented by one or more second storage devices; and
invoking writing of an erasure coded backup copy of the metadata to a plurality of third storage devices.
